(19) United States
(12) Patent Application Publication
(10) Pub. No.: US 2011/0095093 A1
(43) Pub. Date: Apr. 28, 2011

(54) Motor Vehicle and associated operating method

(76) Inventor: Matthias Wöhrle, Hildrizhausen (DE)

(21) Appl. No.: 12/927,871

(22) Filed: Nov. 27, 2010

Related U.S. Application Data
(63) Continuation-in-part of application No. PCT/EP2009/005570, filed on Jul. 31, 2009.

(30) Foreign Application Priority Data
Aug. 9, 2008 (DE) 10 2008 037 238.2

(51) Int. Cl. B60H 1/03

(52) U.S. Cl. 237/12.3 A; 237/81

(57) ABSTRACT

In a method for operating a motor vehicle, in particular a car, comprising an internal combustion engine, a vehicle battery and an occupant cell, the internal combustion engine being operated with a start/stop function wherein the internal combustion engine is switched on and off automatically during the operation of the vehicle in dependence on parameters such as a current drive power demand, and temperature, the start/stop function is activated only if the vehicle battery has a battery temperature which is above a minimum temperature value and the battery is exposed to the heated or cooled air conducted through the occupant cell of the vehicle.

This is a Continuation-In-Part Application of pending international patent application PCT/EP2009/005570 filed Jul. 31, 2009 and claiming the priority of German patent application 10 2008 037 238.2 filed Aug. 9, 2008.

### BACKGROUND OF THE INVENTION

The present invention relates to a motor vehicle including an internal combustion engine for the generation of drive power and having a start-stop function wherein the internal combustion engine is switched off and on again automatically during operation of the vehicle, and also to an associated operating method.

To reduce fuel consumption, it is in principle possible do design motor vehicles comprising an internal combustion engine for the generation of drive power in such a way, that the internal combustion engine can be switched off and on during the operation of the motor vehicle in dependence on the demand for engine power. With the aid of such a start/stop function, the internal combustion engine can for example be switched off in an overrun mode, such as during downhill travel or the coasting down of a vehicle, while all other functions of the vehicle are basically retained. The internal combustion engine is only restarted if propulsive power is once again required. In order to avoid an excessive wear of a vehicle battery required for starting the internal combustion engine, it is expedient to activate the start/stop function only if a battery temperature is above a minimum battery temperature. If the battery temperature falls below the minimum battery temperature, for example at low ambient temperatures, the start/stop function is deactivated to conserve the battery.

There is however a basic desire to reduce fuel consumption even at low ambient temperatures by using the start/stop function.

From DE 195 34 427 B4, an electric vehicle, i.e. a vehicle without an internal combustion engine, is known in which batteries are accommodated in a housing system. To this housing system, a fan can supply an airflow which normally serves to cool the battery. At low ambient temperatures, however, at least a part of the air delivered by the fan can be drawn from the housing system, i.e. from a first region having a higher temperature, while the air delivered by the fan is simultaneously supplied to a second region having a lower temperature in the housing system. In this way, waste heat from the first region can be used to heat the second region.

DE 103 48 385 A1 discloses a fuel cell vehicle with an air-cooled battery, wherein cooled air is taken from an occupant cell of the vehicle and used to cool the battery. A fuel cell vehicle typically does not comprise an internal combustion engine, but at least one electric motor.

It is the object of the present invention to provide an improved motor vehicle with an engine stop/start function and for an associated operating method, which is in particular characterized by the fact that a start/stop function can be implemented relatively easily even at comparatively low ambient temperatures.

### SUMMARY OF THE INVENTION

The invention is based on the general concept of coupling the battery as far as its temperature is concerned to the conditions present in the occupant cell of the vehicle. For this purpose, the battery is subjected to interior air used in the air conditioning of the occupant cell. In this context, the invention makes use of the finding that the occupant cell is usually heated at low ambient temperatures, so that a heating of the battery can be achieved by climatically coupling the occupant cell to the battery. At high temperatures, moreover, the occupant cell is usually cooled, so than an automatic cooling of the battery can be achieved as well. The solution according to the invention does not require any additional heaters or coolers or general air conditioning of the battery. In this way, the battery can be air-conditioned relatively cost-effectively.

According to an advantageous embodiment, the battery may be subjected to a battery airflow which branches off from an interior airflow for air conditioning the occupant cell. By generating an active airflow to be applied to the battery, the air conditioning of the battery can be intensified, thus improving the heating and, if necessary, the cooling of the battery.

In a further development, the battery airflow may branch off from the interior airflow upstream of the occupant cell. This permits an appropriate metering of the battery airflow provided for the air conditioning of the battery.

In another embodiment, interior air from the occupant cell can be supplied to the battery. In this context, the battery is sited downstream of the occupant cell. This variant can be implemented particularly cost-effectively. The battery may for example be disposed in a battery compartment which is connected to the occupant cell by at least one opening. As a result, interior air can flow passively from the occupant cell to the battery compartment and thus to the battery. There is no need for additional measures such as separate air ducting, which makes the implementation of this design cost-effective.

In another advantageous embodiment, an air conditioning device of the vehicle may at least partially draw a recirculation air portion required by the air conditioning device for generating the interior airflow from a battery compartment in which the battery is accommodated and which communicates with the occupant cell. The conditioned interior air fed into the occupant cell consists even in the fresh air mode at least partially and as a rule even mainly of recirculation air drawn from the occupant cell. In this embodiment, the airflow used for the air conditioning of the battery is downstream of the occupant cell, and interior air is actively supplied to the battery compartment.

The invention will become more readily apparent from the following description of particular embodiments thereof with reference to the accompanying drawings.

### BRIEF DESCRIPTION OF THE DRAWINGS

FIGS. 1 to 3 are greatly simplified schematic circuit diagrams of a motor vehicle, showing the different ways of including of a battery compartment into the heating and cooling air flow through a passenger compartment of a motor vehicle.

### DESCRIPTION OF PARTICULAR EMBODIMENTS

According to FIGS. 1 to 3, a motor vehicle 1, which is preferably a passenger car, comprises an internal combustion engine 2, for example a diesel or a gasoline engine. The internal combustion engine 2 provides drive power for the vehicle 1. The vehicle 1 further comprises a battery 3 for supplying the vehicle 1 with electric energy. The battery 3 may consist of a single battery element or of a plurality of battery elements or of a group of individual batteries. The battery 3 is further used for operating a starter alternator 4. In a starter mode, the starter alternator 4 can be used to start the internal combustion engine 2. In an alternator mode, the starter alternator 4 can be used to charge the battery 3. In place of a starter alternator 4, the vehicle 1 may be provided with a conventional starter and with a conventional alternator (generator). A temperature sensor 5 by means of which the temperature of the battery 3, i.e. the momentary battery temperature, can be determined is assigned to the battery 3. The temperature sensor 5 is connected to a control unit 6, by means of which the starter alternator 4 in particular is actuated. The control unit 6 is in particular provided for the implementation of a start/stop function for the internal combustion engine 2. For this purpose, the control unit 6 may in addition be coupled to the internal combustion engine 2. The start/stop function is in particular activated and deactivated in dependence on the battery temperature, which will be explained in greater detail below.

The vehicle 1 further comprises an air conditioning device 7, by means of which an occupant cell 8 of the vehicle 1 can be heated. The air conditioning device 7 is expediently designed such that it can also cool and/or dehumidify the occupant cell 8. The air conditioning device 7 comprises at least one fresh air inlet 9, at least one recirculation air inlet 10 and at least one outlet 11 for conditioned air. Through the fresh air inlet 9, the air conditioning device 7 can draw in fresh air from the ambient of the vehicle. Through the recirculation air inlet 10, the air conditioning device 7 can draw in air from the occupant cell 8. Through the outlet 11, the air conditioning device 7 can feed conditioned air into the occupant cell 8.

In the illustrated embodiment, the battery 3 is accommodated in a battery compartment 12 which is separated from the interior 8, for example by an insulation wall and/or a carpet 13. The battery compartment 12 is in particular sited below a foot-well region of the occupant cell 8, which is not shown in detail.

In the operation of the motor vehicle, the control unit 6 can operate the internal combustion engine 2 using the above-mentioned start-stop function. If the start/stop function is active, the internal combustion engine 2 is switched on and off automatically in dependence on parameters. Parameters which result in the switching on or off of the internal combustion engine 2 include the current drive power demand of the vehicle 1. When braking, driving downhill or coasting, the internal combustion engine 2 can be switched off. When starting, accelerating or driving uphill, the internal combustion engine 2 is of course switched on. In conjunction with an effective quick start method which requires only little fuel, the start/stop function can contribute significantly to the reduction of fuel consumption.

To conserve the battery 3, the control unit 6 may be designed such that it activates the start/stop function only if the battery temperature exceeds a minimum battery temperature. This minimum battery temperature may for example lie in the range from 0° C. to −3° C. inclusive. Although the battery 3 is capable of starting the internal combustion engine 2 at such low temperatures in order to operate the vehicle 1, its power reserves would quickly be reduced to an excessively low level by multiple starting operations such as would occur in the start/stop function. In view of this, the control unit 6 activates the start/stop function only above the minimum battery temperature.

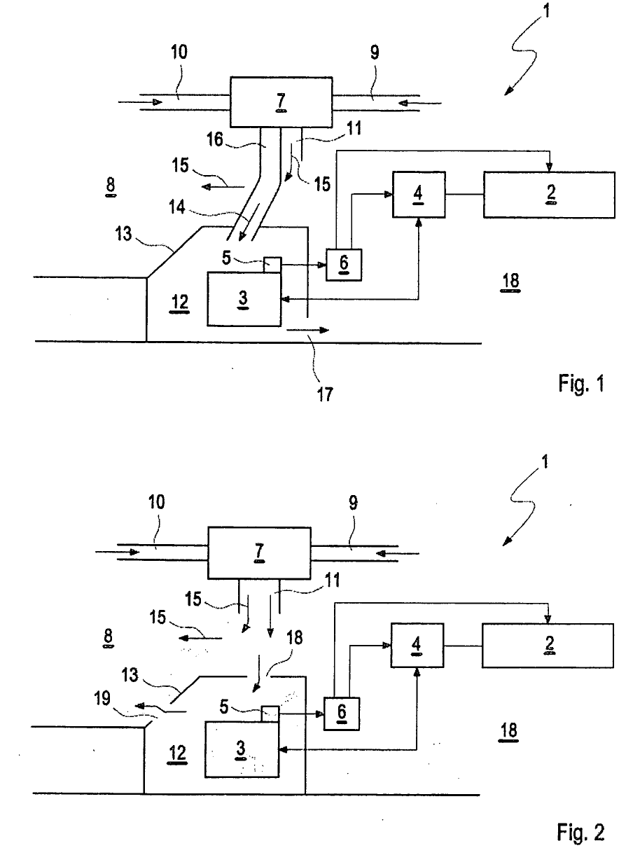

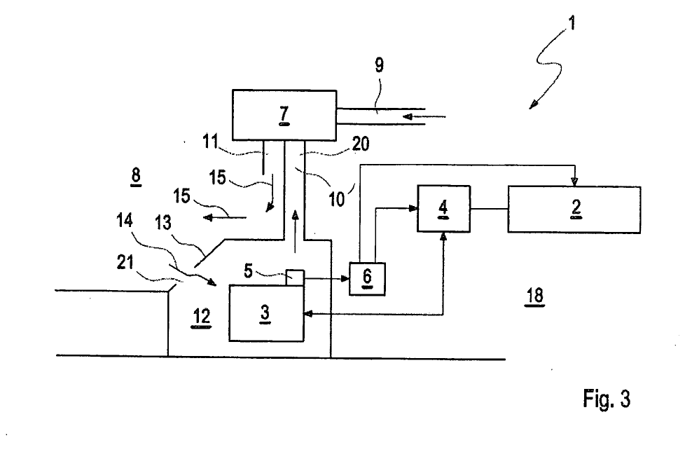

In order to reach the minimum battery temperature as quickly as possible even at low ambient temperatures, the battery 3 is subjected to interior air used for air conditioning the occupant cell 8. According to FIGS. 1 and 3, this may be achieved actively by subjecting the battery 3 to an interior airflow, or passively as shown in FIG. 2, essentially by means of a convective air exchange.

According to FIGS. 1 and 3, the battery 3 may for example be subjected to a battery airflow 14 indicated by arrows. This battery airflow 14 branches off an interior airflow 15 for the air conditioning of the occupant cell 8, which is likewise indicated by arrows. In the embodiment shown in FIG. 1, the battery airflow 14 branches off the interior airflow 15 upstream of the occupant cell 8. For this purpose, the air conditioning device 7 may be provided with an outlet duct 16 which delivers the conditioned air, i.e. the battery airflow 14, to the battery compartment 12. From the battery compartment 12, the battery airflow 14 can escape, for example via an opening 17, into the surroundings of the vehicle or into an engine compartment 18 of the vehicle. As an alternative, the battery airflow 14 may be ducted from the battery compartment 12 into the occupant cell 8.

In the embodiment shown in FIG. 2, the battery compartment 12 communicates with the occupant cell 8 via at least one opening 18, 19. In this embodiment, two openings are shown, these being an inlet 18 and an outlet 19. The communication between the battery compartment 12 and the occupant cell 8 is expediently designed such that interior air flows passively from the occupant cell 8, for example via the inlet 18, into the battery compartment 12. For a convective flow, the at least one outlet 19 may be placed below the at least one inlet 18 and allow the air to be discharged from the battery compartment 12 into the occupant cell 8. If temperature conditions are reversed, i.e. if the air conditioning device 7 is used to cool the occupant cell 8, cool air enters the battery compartment 12 through the lower opening 19, which then acts as the inlet, and can be discharged from the battery compartment 12 by convection through the upper opening 18, which then acts as the outlet. The embodiment shown in FIG. 2 is provided with an inlet duct 20 which connects a recirculation air inlet 10 of the air conditioning device to the battery compartment 12. This may be the sole recirculation air inlet 10 of the air conditioning device 7. Alternatively, there may be an additional recirculation air inlet 10 of the air conditioning device 7, which may be provided in addition to the recirculation air inlets 10 which are directly open to the occupant cell 8 as shown on FIGS. 1 and 2. Through this inlet duct 10′, the fresh air system 7 can draw recirculation air in a demand-dependent manner directly from the battery compartment 12 and indirectly from the occupant cell 8 through the former.

For this purpose, the battery compartment 12 is connected to the occupant cell 8 via at least one opening 21. The air drawn from the battery compartment 12 can then flow back from the occupant cell 8 into the battery compartment 12. This design is based on the established fact that the air conditioning device 7 will draw at least a part of the air from the occupant cell 8 even in the fresh air operating mode. If the occupant cell 8 is heated by the air conditioning device 7, the battery will be heated as well after some time delay.

At high temperatures, the occupant cell 8 is usually cooled by means of the air conditioning device 7, either passively by introducing fresh air at ambient temperature or actively by cooling the interior airflow 15. As a result, the battery 3 is then subjected to cooled interior air, either actively by being subjected to a cooled battery airflow 14 according to FIG. 1 or by drawing in cool ambient air 14 according to FIG. 3, or passively by the exchange of cooled interior air between the occupant cell 8 and the battery compartment 12 as shown in FIG. 2. A cooling of the battery 3 at higher temperatures is highly desirable if the overheating of the battery 3 is to be avoided.

The control unit 6 may in addition be designed such that it allows for a recuperative function. Such a recuperative function converts the mechanical energy of the vehicle into electric energy, which can then be used to charge the battery 3. For this purpose, the starter alternator 4 is operated as a generator. The recuperative function is useful whenever the internal combustion engine 2 is switched off. The recuperative function may for example be activated when braking the vehicle 1 and/or when travelling downhill with the vehicle 1. The control unit 6 preferably activates the recuperative function only if the battery temperature is above a minimum recuperation temperature. This minimum recuperation temperature is expediently higher than the minimum battery temperature and may for example be approximately 8° C.

What is claimed is:

1. Method for operating a motor vehicle (1) comprising an occupant cell (8), an internal combustion engine (2) and a vehicle battery (3), in particular a passenger car with an occupant cell (8), said method comprising the steps of:
operating the internal combustion engine (2) with a start/stop function wherein the internal combustion engine (2) is switched on and off automatically during the operation of the vehicle (1) in dependence on parameters including a momentary drive power demand,
activating the start/stop function only if the vehicle battery (3) has a battery temperature which is above a minimum battery temperature, and
subjecting the battery (3) to interior air supplied to the occupant cell (8) for heating the occupant cell (8) of the vehicle (1).

2. The method according to claim 1, wherein the battery (3) is subjected to a battery airflow (14) which branches off from an interior airflow (15) for heating the occupant cell (8).

3. The method according to claim 2, wherein the battery airflow (14) branches off from the interior airflow (15) upstream of the occupant cell (8).

4. The method according to claim 1, wherein interior air from the occupant cell (8) is supplied to the battery (3).

5. The method according to claim 4, wherein the battery (3) is located in a battery compartment (12) which is connected to the occupant cell (8) by at least one opening (18, 19) in such a way that interior air flows passively from the occupant cell (8) into the battery compartment (12) and to the battery (3).

6. The method according to claim 4, wherein, for generating the interior airflow (15), a recirculation air portion of an air conditioning device (7) of the vehicle (1) is, at least partially, drawn from a battery compartment (12) in which the battery (3) is accommodated and which is in communication with the occupant cell (8) by at least one opening (21).

7. The method according to claim 1, wherein a recuperative function for charging the battery (3) is activated only if the vehicle battery (3) has a battery temperature which is above a predetermined minimum recuperation temperature.

8. The method according to claim 7, wherein the minimum recuperation temperature is higher than the minimum battery temperature.

9. A motor vehicle, including
an occupant cell (8),
an internal combustion engine (2),
a battery (3) accommodated in a battery compartment (12),
an air conditioning device (7),
the motor vehicle being equipped with a start/stop system for operating a start/stop function,
the start/stop function being activated only if the battery (3) has a battery temperature which is above a minimum battery temperature, and
the air conditioning device (7) for heating the occupant cell (8) of the vehicle (1) being in communication with the battery compartment (12) on the outlet or inlet side thereof.

10. The motor vehicle according to claim 9, wherein the air conditioning device (7) has an outlet duct (16) for conducting conditioned air to the battery compartment (12).

11. The motor vehicle according to claim 9, wherein the air conditioning device (7) has an inlet duct (20) through which the air conditioning device (7) draws air from the battery compartment (12), which flows through at least one opening (21) from the occupant cell (8) into the battery compartment (12).

12. The motor vehicle according to claim 9, wherein a control unit (6) is provided for the control of a method for operating the motor vehicle (1) for operating the internal combustion engine (2) with the start/stop function wherein the internal combustion engine (2) is switched on and off automatically during the operation of the vehicle (1) in dependence on parameters including a momentary drive power demand, but only if the vehicle battery (3) has a battery temperature which is above a minimum battery temperature, and by exposing the battery (3) to interior air supplied to the occupant cell (8) for heating the occupant cell (8) of the vehicle (1).
